(19) United States
(12) Patent Application Publication
(10) Pub. No.: US 2026/0221758 A1
(43) Pub. Date: Jul. 30, 2026

(54) POWER SUPPLY UNIT AND CIRCUIT BREAKER

(71) Applicant: EATON INTELLIGENT POWER LIMITED, Dublin 4 (IE)

(72) Inventor: Ingo SCHAAR, Bonn (DE)

(21) Appl. No.: 19/146,594

(22) PCT Filed: Feb. 8, 2024
(86) PCT No.: PCT/EP2024/025067

§ 371 Date: Jul. 9, 2025

(30) Foreign Application Priority Data
Feb. 10, 2023 (DE) 10 2023 103 306.9

(51) Int. Cl. H02H 7/08; H01F 27/40; H01F 38/38; H02H 1/06; H02H 3/05; H02H 3/08

(52) U.S. Cl. CPC H02H 7/08; H01F 27/402; H01F 38/38; H02H 1/06; H02H 3/05; H02H 3/083

(57) ABSTRACT

Some embodiments relate to a power supply unit for use in a three-phase ac system including
a transformer, and
a first phase conductor, a second phase conductor and a third phase conductor forming respective first, second and third primary windings of the transformer,
A winding direction of the third primary winding is opposite to a winding direction of the first and second primary windings and/or
a winding number of the third primary winding is different from a winding number of the first primary winding or the second primary winding.

### CROSS-REFERENCE TO RELATED APPLICATIONS

This application is a national phase filing under 35 C.F.R. § 371 of and claims priority to PCT Patent Application No. PCT/EP2024/025067, filed on Feb. 8, 2024, which claims priority to German Application No. 10 2023 103 306.9, filed on Feb. 10, 2023, the contents of which are hereby incorporated in their entireties by reference.

A power supply unit and a circuit breaker are specified herein.

Circuit breakers may be used to protect electronic circuits from short circuits and/or to protect electric devices, such as electric motors, from electric overloads. Digital or electronic circuit breakers can comprise electronic components, such as control units or trip units, configured for monitoring an electric current flowing through the circuit breaker during operation. These electronic components usually require an electric power supply unit. For example, the power supply unit may extract the electric power from the electric current flowing through the circuit breaker during operation. In this case no additional connections for supplying power to the trip unit are needed. In the case of a circuit breaker for a three phase ac system, the power supply unit may extract the electric power from one or more of the three phases, for example. However, it might be desirable that the power supply of the trip unit remains functional if one or two of the three phases fail or are lost, such that the circuit breaker remains functional also in the case of a phase failure or of a phase loss.

At least one object of certain embodiments is to provide a compact power supply unit for use in a three phase ac system that remains functional if all but one of the three phases fail.

This object is achieved by the subject matter of the independent claim. Further embodiments and further advantageous developments are specified in the dependent claims.

According to an embodiment, the power supply unit for use in a three phase ac system comprises a transformer. In particular, the transformer transfers electric energy from a primary electric circuit to a secondary electric circuit via electromagnetic induction. The primary electric circuit and secondary electric circuit may be galvanically isolated from each other. For example, the transformer comprises a magnetic core, one or more primary windings connected to the primary electric circuit, and one or more secondary windings connected to the secondary electric circuit. Moreover, the transformer may be configured to convert an ac input voltage to an ac output voltage with a different amplitude. For example, the input voltage is provided by the primary electric circuit, whereas the output voltage is applied and/or supplied to the secondary electric circuit. For example, the output voltage has a larger or a smaller amplitude than the input voltage.

The magnetic core is configured to guide or direct a magnetic flux. For example, the magnetic core guides the magnetic flux generated by an electric current flowing through the one or more primary windings to the one or more secondary windings. For example, the magnetic core has a ring form, a rectangular form, a shell form, or any other form or shape that may be used in a transformer. Preferably, the magnetic core comprises a magnetic material with a high magnetic permeability, such as iron or a ceramic ferrite material, for example.

For example, the one or more primary windings and/or the one or more secondary windings comprise an electrically isolated, conductive wire wound around the magnetic core. If the transformer comprises more than one primary winding, the primary windings may be electrically isolated from each other. If the transformer comprises more than one secondary winding, the secondary windings may be electrically isolated from each other. Each winding of the transformer may comprise a predetermined number of turns. Here and in the following, the number of turns of a given winding specifies the number of times the conductive wire of said winding is wound around the magnetic core. The number of turns may be an integer. Alternatively or in addition, the number of turns may also include a fraction of an integer, if one turn of the winding is only partially wound around the magnetic core. For example, a turn that is partially wound around the magnetic core is wound around a fraction of a circumference of the magnetic core.

According to a further embodiment, the power supply unit for use in a three phase ac system comprises a first phase conductor, a second phase conductor and a third phase conductor forming respective first, second and third primary windings of the transformer. For example, an alternating electric voltage and/or an alternating electric current is 120° out of phase between each pair of the first, second and third phase conductors. In particular, each of the first, second and third phase conductors comprises a conductive wire that is wound around the magnetic core of the transformer and forms the first, second and third primary windings.

Preferably, the first, second and third primary windings are electrically isolated from each other.

According to a further embodiment of the power supply unit for use in a three phase ac system, a winding direction of the third primary winding is opposite to a winding direction of the first and second primary windings. For example, the first and the second primary windings comprise turns that are wound clockwise around the magnetic core, whereas the third primary winding comprises turns that are wound anti-clockwise around the magnetic core, or vice versa. In other words, the third primary winding has a different polarity than the first primary winding and the second primary winding.

Due to the different winding direction of the third primary winding compared to the first and second primary windings, the magnetic flux generated by an ac electric current flowing through the third primary winding has an additional phase shift of 180° compared to the magnetic fluxes generated by ac electric currents flowing through the first and second primary windings, respectively. In other words, an electric current induced in the secondary winding of the transformer that is generated by the ac electric current flowing through the third primary winding has an additional 180° phase shift compared to induced electric currents in the secondary winding that are generated by the ac electric currents flowing through the first and second primary windings.

According to a further embodiment of the power supply unit for use in a three phase ac system, a winding number of the third primary winding is different from a winding number of the first primary winding or the second primary winding. Here and in the following, the winding number of a winding is equal of the number of turns of that winding. For example, the third primary winding has a larger number of turns or a smaller number of turns than the first primary winding or the second primary winding. For example, all of the three primary windings may have different winding numbers, or the first and the second primary windings may have equal winding numbers.

According to a preferred embodiment, the power supply unit for use in a three-phase ac system comprises:
a transformer, and
a first phase conductor, a second phase conductor and a third phase conductor forming respective first, second and third primary windings of the transformer, wherein
a winding direction of the third primary winding is opposite to a winding direction of the first and second primary windings, and/or
a winding number of the third primary winding is different from a winding number of the first primary winding or the second primary winding.

The power supply unit disclosed herein is based on the idea that only a single transformer is used instead of three separate transformers for each of the three phases. Accordingly, the power supply unit described herein is particularly compact. Moreover, since all three phases are coupled to the same transformer, the power supply unit generates an electric output voltage and/or an electric output current, even if one or two of the three phases fail or are lost. Accordingly, the power supply unit described herein is particularly robust with regard to a loss of all but one of the three phases. By contrast, if only one of the three phases would form a primary winding of the transformer, and if this particular phase would fail or be lost, the power supply unit would not generate an electric output voltage and would therefore loose its functionality.

Importantly, if the three phases have a mutual phase shift of 120° and if the three phases are coupled to the same transformer in an identical manner, the total output voltage and/or the total output current might sum to zero. Indeed, the total output voltage is the sum of the voltages induced by each of the three phases, for example. In case of a mutual 120° phase shift and in case of equal voltage amplitudes, the total output voltage might thus sum to zero.

In order to generate a non-zero root-mean-square (RMS) value of the electric output voltage and/or the electric output current in the case of a mutual 120° phase shift between the three phases, at least one of the three phases should be coupled differently to the transformer than the other two phases. For example, a winding direction and/or a winding number of a primary winding corresponding to one of the three phases could be different compared to the other two phases.

In particular, by using a different winding direction for one of the three phases, the respective phase generates an output voltage in the secondary winding with an additional 180° phase shift compared to the other two phases. Accordingly, the output voltages induced by the three phases in the secondary winding sum to a non-zero RMS value. Alternatively or in addition, by using different winding numbers for the primary windings corresponding to the three phases, the output voltages induced by the three phases in the secondary winding sum to a non-zero RMS value. Advantageously, the RMS value of the output voltage remains non-zero, if the electric input voltage and/or the electric input current of one or two of the three phases are zero, that is if one or two of the three phases fail or are lost.

According to a further embodiment of the power supply unit for use in a three phase ac system, the transformer comprises a secondary winding such that a magnetic flux through the secondary winding corresponds to a sum of magnetic fluxes generated by the first, second and third primary windings during operation of the power supply unit. In other words, the secondary winding of the transformer is coupled to all three primary windings corresponding to the three phases simultaneously. For example, the transformer comprises a torus-shaped or ring-shaped magnetic core and the all three primary windings as well as the secondary winding are wound along a poloidal direction of the torus-shaped magnetic core. As another example, the transformer may comprise a shell-type magnetic core and all primary as well as secondary windings are wound around the same central limb of the shell-type magnetic core. The number of turns of the secondary winding may be chosen such the output voltage has a predetermined amplitude. The transformer also may comprise two or more secondary windings.

According to a further embodiment of the power supply unit for use in a three phase ac system, at least one of the primary windings is a half-turn winding. Here and in the following, a half-turn winding has a number of turns that is equal or approximately equal to one half. For example, all primary windings are half-turn windings. For example, the transformer comprises a torus-shaped magnetic core and the three phase conductors comprise substantially straight portions that pass through a center hole of the torus-shaped magnetic core in a direction parallel to a main axis of the torus-shaped magnetic core. In this case, the two different winding directions correspond to two opposite directions parallel to the main axis of the torus-shaped magnetic core.

According to a further embodiment, the power supply unit further comprises an electronic circuit configured for generating a constant dc output voltage from an output voltage of the transformer. For example, the electronic circuit comprises a rectifier configured for rectifying the ac output voltage of the transformer and to generate a dc output voltage. Moreover, the electronic circuit may comprise a voltage regulator configured to generate a constant dc output voltage independent of an amplitude of the ac output voltage of the transformer, at least as long as the amplitude of the ac output voltage of the transformer lies within predetermined limits. For example, the dc output voltage of the electronic circuit remains constant if the amplitude of the ac output voltage of the transformer drops to one half of its nominal value. For example, in this case the dc output voltage of the electronic circuit advantageously remains constant, even if one or two of the three input phases coupled to the transformer fail or are lost.

Further, an electronic circuit breaker is specified herein. In particular, the electronic circuit breaker comprises a power supply unit as specified above. All features of the power supply unit are also disclosed for the electronic circuit breaker and vice versa.

According to an embodiment, the electronic circuit breaker for use in a three-phase ac system comprises a power supply unit as specified above, wherein the power supply unit is configured to supply electric power to a trip unit of the electronic circuit breaker. For example, the trip unit is configured for monitoring a current that flows through the circuit breaker during operation. Moreover, the trip unit may be configured for switching or braking the electric current that flows through the circuit breaker during operation, if the monitored current is outside a predetermined range, for example.

According to a further embodiment of the electronic circuit breaker, the trip unit comprises at least one current sensor for monitoring an electric current flowing through the circuit breaker. For example, the trip unit comprises a separate current sensor for each of the three phases connected to the circuit breaker. For example, the transformer may or may not be used for both, as part of the power supply unit and for measuring the current flowing through the circuit breaker during operation.

According to a further embodiment of the electronic circuit breaker, the current sensor is a Hall sensor. The Hall sensor is an indirect current sensor that detects a strength of a magnetic field generated by the electric current that is to be sensed. Alternatively or in addition the, current sensor may be a magneto-resistive current sensor, a fluxgate sensor, or a current sensor for direct current sensing, such as a resistor that generates a voltage drop proportional to the current to be sensed.

According to a further embodiment, the electronic circuit breaker is configured as a protective switch for an electric three-phase ac motor. For example, the electronic circuit breaker is configured to protect the electric three-phase ac motor from a short circuit or an electric overload. For example, the electronic circuit breaker electrically separates the motor from one or more of the three phase conductors, if the electric current carried by at least one of the three phase conductors as measured by the trip unit is abnormal.

Further advantageous embodiments and further embodiments of the contactor arrangement and the method for operating a contactor arrangement become apparent from the following exemplary embodiments described in connection with the figures.

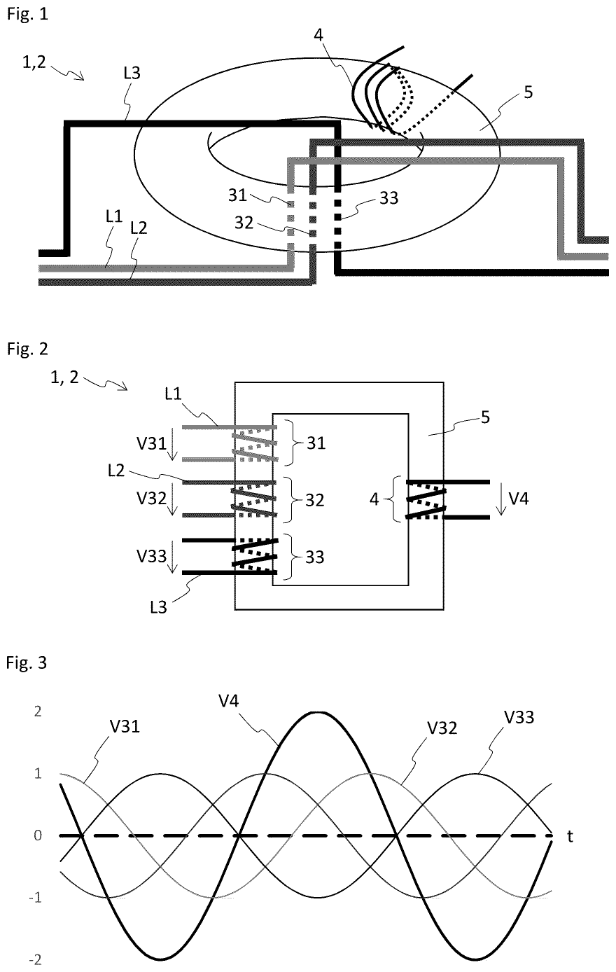

FIG. 1 shows a schematic perspective view of a power supply unit according to an exemplary embodiment.

FIG. 2 shows a schematic view of a power supply unit according to a further exemplary embodiment.

FIG. 3 shows a schematic graph depicting voltages as a function of time during operation of a power supply unit according to an exemplary embodiment.

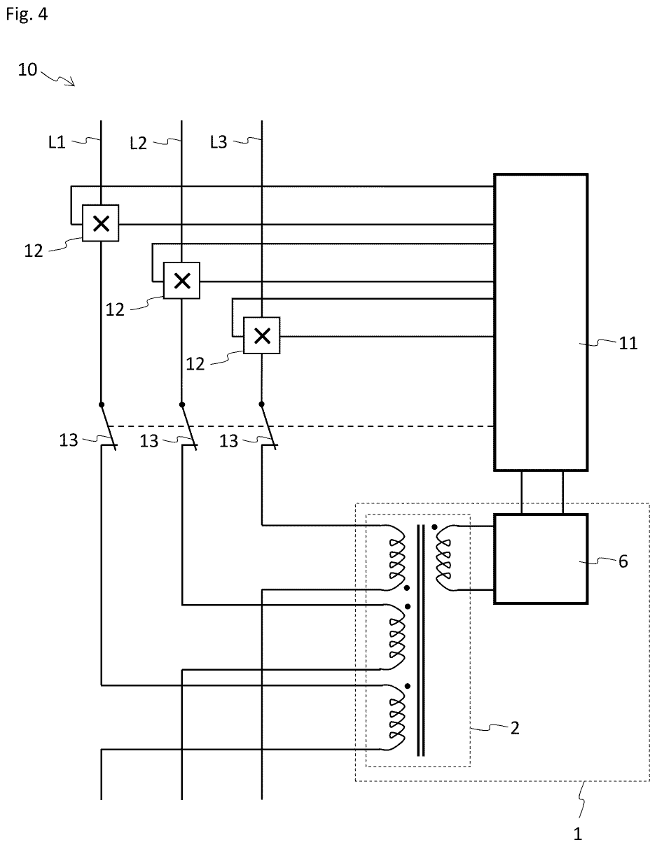

FIG. 4 shows a schematic circuit diagram of an electric circuit breaker according to an exemplary embodiment.

Elements that are identical, similar, or have the same effect, are denoted by the same reference signs in the figures. The figures and the proportions of the elements shown in the figures are not to be regarded as true to scale. Rather, individual elements may be shown exaggeratedly large for better representability and/or better understanding.

The power supply unit 1 according to the exemplary embodiment in FIG. 1 comprises a transformer 2 for use in a three phase ac system. The transformer 2 comprises a torus-shaped magnetic core 5, a first phase conductor L1 forming a first primary winding 31, a second phase conductor L2 forming a second primary winding 32, and a third phase conductor L3 forming a third primary winding 33 of the transformer 2. A secondary winding 4 is wound in a poloidal direction around the magnetic core 5.

Each of the first, second and third primary windings 31, 32, 33 is formed as a half-turn winding. In other words, each of the first, second and third phase L1, L2, L3 conductors comprises a straight or substantially straight portion that passes through a central hole of the torus-shaped magnetic core 5 in a direction parallel to a main axis of the torus-shaped magnetic core 5. A magnetic flux generated by these straight or substantially straight portions of the phase conductors L1, L2, L3 during operation is coupled to the secondary winding via the magnetic core 5.

The three phase conductors L1, L2, L3 carry an ac electric current during operation that has a phase shift of 120° between each pair of the three phase conductors L1, L2, L3. In order to induce a non-zero electric voltage in the secondary winding 4, the winding direction of the third primary winding 33 is opposite to the winding direction of the first and second primary windings 31, 32.

The power supply unit 1 according to the further exemplary embodiment in FIG. 2 comprises a transformer 2 for use in a three phase ac system. In contrast to the exemplary embodiment descried in connection with FIG. 1, the first, second, and third primary windings 31, 32, 33 each comprise multiple turns that are wound around the magnetic core 5. The number of turns in each of the three primary windings 31, 32, 33 is equal. The winding direction of the first and second primary windings 31, 32 is clockwise, whereas the winding direction of the third primary winding 33 is anti-clockwise. Accordingly, the voltage induced in the secondary winding 4 by the third primary winding 33 has an additional 180° phase shift. Consequently, during operation of the transformer 2, the output voltage V4 of the transformer 2 at least approximately follows from the relation

$$V 4 = \frac{Ns}{Np} ( V 31 + V 32 - V 33 ) , \qquad ( Eq 1 )$$

where V31, V32 and V33 denote the input voltages of the first, second and third primary windings, respectively, whereas Np denotes the number of turns of each primary winding and Ns denotes the number of turns of the secondary winding 4.

In an alternative exemplary embodiment, the transformer 2 has basically the same form as shown in FIG. 2, but the number of turns in each of the three primary windings 31, 32, 33 is different, while their winding directions are all equal.

The schematic graph in FIG. 3 schematically shows the voltages indicated in FIG. 2 as a function of time t during operation of the transformer 2. In particular, the ac input voltages V31, V32 and V33 applied to the three primary windings 31, 32, 33, respectively, have an equal amplitude and a mutual phase shift of 120°. The output voltage V4 of the transformer 2 follows from Eq1 above and is depicted here for an equal number of turns in the primary and secondary windings, Np=Ns. In particular, due to the opposite winding direction of the third primary winding 33 compared to the first and second primary windings 31, 32, the output voltage V4 sums to a non-zero RMS value.

The electronic circuit breaker 10 for use in a three-phase ac system according to the exemplary embodiment shown in FIG. 4 comprises a power supply unit 1, three switches 13 and a trip unit 11 with three current sensors 12. The power supply unit 1 comprises a transformer 2 as described in connection with FIG. 1 or 2.

The three primary windings 31, 32, 33 of the transformer 2 are electrically connected to the three phase conductors L1, L2, L3, respectively. Furthermore, the three switches 13 are operated by the trip unit 11 and are configured to break the three phase conductors L1, L2, L3, respectively, if a short circuit or an electric overload is detected by the trip unit 11.

The power supply unit 1 comprises an electronic circuit 6 configured for converting the output voltage V4 of the transformer 2 to a constant dc output voltage. The output voltage of the electronic circuit 6 remains constant, even if one or two of the three phase conductors L1, L2, L3 fail or are lost during operation.

The power supply unit 1 provides electric power for operating the trip unit 11. The trip unit 11 comprises three current sensors 12 in the form of Hall sensors that are configured to measure the electric currents flowing through the three phase conductors L1, L2, L3 during operation. The trip unit 11 monitors the electric currents during operation and opens one or all of the switches 13, if a short circuit or an overload is detected.

The presently disclosed subject matter is not restricted to the exemplary embodiments by the description on the basis of said exemplary embodiments. Rather, the presently disclosed subject matter encompasses any new feature and also any combination of features, which in particular comprises any combination of features in the patent claims and any combination of features in the exemplary embodiments, even if this feature or this combination itself is not explicitly specified in the patent claims or exemplary embodiments.

### REFERENCE SIGNS

1 power supply unit
2 transformer
31 first primary winding
32 second primary winding
33 third primary winding
4 secondary winding
5 magnetic core
6 electronic circuit
10 electronic circuit breaker
11 trip unit
12 current sensor
13 switch
L1 first phase conductor
L2 second phase conductor
L3 third phase conductor
V31 first primary voltage
V32 second primary voltage
V33 third primary voltage
V4 output voltage
t time

1. A power supply unit for use in a three-phase ac system comprising:
a transformer, and
a first phase conductor, a second phase conductor and a third phase conductor forming respective first, second and third primary windings of the transformer, wherein
alternating electric voltages and/or alternating electric currents are 120° out of phase between each pair of the first phase conductor, the second phase conductor, and the third phase conductor,
a winding direction of the third primary winding is opposite to a winding direction of the first and second primary windings, and/or
a winding number of the third primary winding is different from a winding number of the first primary winding or the second primary winding.

2. The power supply unit according to the previous claim 1, wherein the transformer comprises a secondary winding such that a magnetic flux through the secondary winding corresponds to a sum of magnetic fluxes generated by the first, second and third primary windings during operation of the power supply unit.

3. The power supply unit according to claim 1, wherein at least one of the primary windings is a half-turn winding.

4. The power supply unit according to claim 1, further comprising an electronic circuit configured for generating a constant dc voltage from an output voltage of the transformer.

5. An electronic circuit breaker for use in a three-phase ac system comprising a power supply unit according to claim 1, wherein the power supply unit is configured to supply electric power to a trip unit of the electronic circuit breaker.

6. The electronic circuit breaker according to the previous claim 5, wherein the trip unit comprises at least one current sensor for monitoring an electric current flowing through the circuit breaker.

7. The electronic circuit breaker according to claim 6, wherein the current sensor is a Hall sensor.

8. The electronic circuit breaker according to claim 5, wherein the electronic circuit breaker is configured as a protective switch for an electric three-phase ac motor.
